(19) United States
(12) Patent Application Publication
(10) Pub. No.: US 2012/0099816 A1
(43) Pub. Date: Apr. 26, 2012

(54) PHOTONICS MODULE AND METHOD OF MANUFACTURING

(75) Inventor: Stewart W. Wilson, Billerica, MA (US)

(73) Assignee: PALOMAR MEDICAL TECHNOLOGIES, INC., Burlington, MA (US)

(21) Appl. No.: 12/911,177

(22) Filed: Oct. 25, 2010

(51) Int. Cl. G02B 6/32; B23P 11/00

(52) U.S. Cl. 385/33; 29/428

(57) ABSTRACT

An improved photonics module includes a Silicon motherboard having a plurality of v-grooves that collimate and optically align a laser diode emission is held within an enclosure that includes two or more positioning portions that locate and guide the Silicon motherboard in the desired position within the enclosure. The enclosure acts as a heat sink that provides stability and aids in wicking Silicon motherboard mounting material such damage to the Silicon motherboard by the mounting material is avoided. Methods of making the improved photonics module are also disclosed.

### BACKGROUND

Photonics modules can include an optical component (e.g., an optical fiber and/or an optical lens) that is aligned with a photonic device. Currently, photonics modules having relatively high optical power (e.g., greater than 1 W) and relatively lower optical coupling loss (e.g., less than about 15% optical coupling loss) take a relatively long time to manufacture, require operator skill, and require operator intervention and/or high cost equipment to manufacture, and are, accordingly, relatively costly to manufacture. As a result, currently available photonics modules are employed in relatively higher cost end user applications (e.g., end user applications that are targeted for a professional practitioner rather than an end user such as a consumer). It is desirable to design a photonics module that is suitable for application in a device having a lower price point relative to current devices that incorporate photonics module(s).

The generation of a high optical power (e.g., greater than 1 W) delivered from an optical fiber generally requires an energy source that efficiently couples with an optical fiber. For example, suitable high optical power devices can include (1) a diode laser and (2) efficient coupling into the optical fiber.

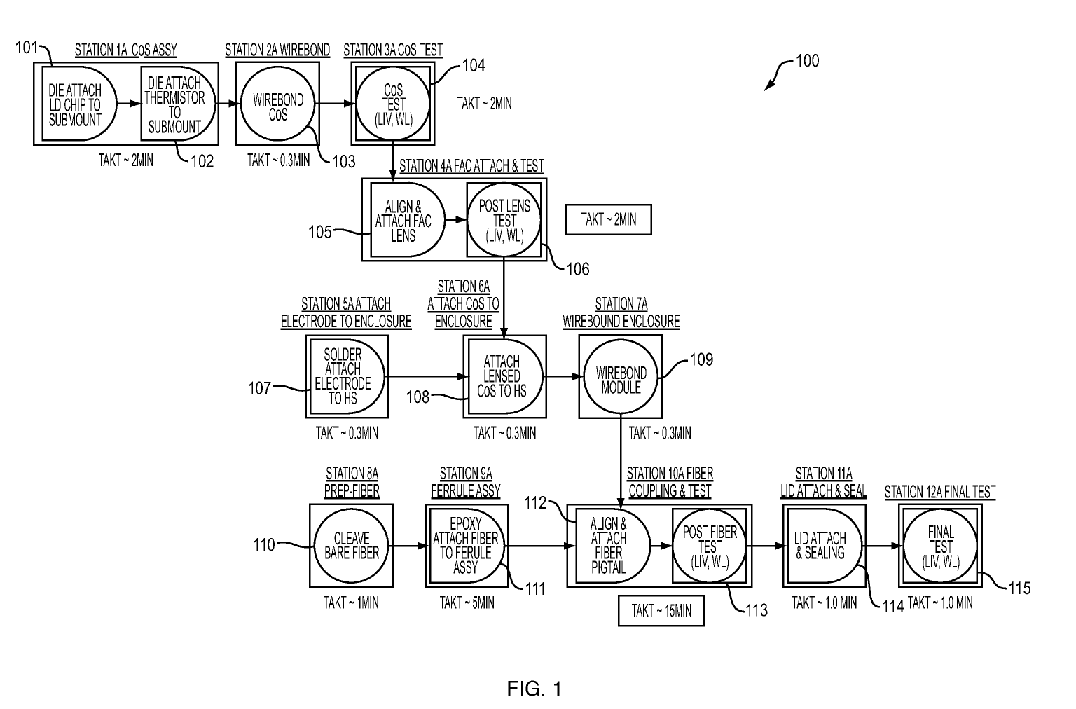

FIG. 1 provides an example of a presently available photonics module manufacturing process flow 100. This exemplary process flow includes fifteen operations. Any one of these fifteen operations is manual, automated, or a combination thereof. In the first operation 101 the laser diode is die attached to the submount. In this operation 101 the diode laser can be a diode laser chip that is mounted p-side down (e.g., positive side down, also referred to as anode side down) onto a submount.

The submount should be a highly thermally conductive material. The desired thermal conductivity of the submount material is typically greater than about 180 W/m-K with a thermal expansion close to the thermal expansion of the diode laser (e.g., from about 4 ppm/K to about 8 ppm/K). Suitable materials that can be employed as submounts include but are not limited to, for example, WCu, AN, SiC and BeO. It is particularly desirable to use a diode laser and a submount material that have similar thermal expansion characteristics when a hard solder is employed to mount the diode laser to the submount, otherwise there is a risk of stress caused by a mismatch of these thermal expansion characteristics that could degrade the lifetime and/or performance of the diode laser. Hard solders are generally used to die attach the diode laser (e.g., the diode laser chip) to the submount. Hard solders are generally used, because they provide the most stability over the life of a photonics module and/or the end device in which the photonics module is employed. Examples of typical hard solders that can be employed include, but are not limited to, AuSn and AuGe alloys.

Referring still to FIG. 1, in the next operation, operation 102, a thermistor is die attached to the submount. The thermistor is a resistor whose resistance varies according to its temperature. Station 1A of the process flow includes operations 101 and 102 in which the Chip on Submount (CoS) assembly is formed.

The “takt time” is defined the time required to produce a product at a given operational step in the assembly sequence in order to meet demand and it is calculated by dividing the minutes of work time per day by the total customer demand or the units produced per day. Thus, the takt time is equal to the minutes of work per unit produced. In essence, the takt time would determine that maximum capacity at a given operational step. Hence, the maximum takt time in the entire assembly sequence limits the capacity the line is capable of producing.

Referring again to FIG. 1, the takt time for station 1A to produce the CoS assembly is about 2 minutes. In station 2A, operation 103 is conducted in which the CoS is wirebonded, the takt time for station 2A is about 0.3 minutes. The CoS is wirebonded in order to provide electrical connectivity for the various components (e.g., the thermistor and the LD Chip) to the outside world (e.g., provides electrical connectivity of the thermistor and the LD Chip to other parts of the system, for example, the power supply, test station, or other control system).

Operation 104 occurs in station 3A. In operation 104 the chip on submount formed by operations 101, 102, and 103 is tested. During this test the optoelectronic characteristics for the given device are obtained. Namely, the optical power, voltage and wavelength are measured as a function of electrical current. This operation can be manual, automated, or a combination of the two. In operation 104 at station 3A the CoS test requires a takt time of about 2 minutes.

It is critical that there be efficient light coupling (or light collection) into the optical fiber. Since the fast axis of the diode laser is generally highly divergent from the diode laser, a fast axis collimating (FAC) lens can be used to collapse the far field emission(s) of the laser diode thereby to match or align the now collimated diode laser emission with the optical fiber.

In an exemplary photonics module, both the FAC lens and the optical fiber are actively aligned with the diode laser. The diode laser emission travels through the FAC lens prior to traveling through the optical fiber. In one embodiment, the FAC lens is aligned prior to the alignment of the optical fiber. Active alignment is when the device is actively operated in order to produce light emission and the output coupled light is monitored for both profile and optical power until each of the profile and the optical power are obtained (e.g., within a desired range which can include an optimal value).

Referring again to FIG. 1, in operation 105, the photonics module manufacturing process next includes a first step of aligning the FAC lens and a second step of attaching the FAC lens. Both aligning and attaching the FAC lens occurs simultaneously while the diode laser is in operation and is emitting light. In this aligning and attaching step, the FAC lens can be manipulated while the diode laser is in operation to enable the desired emission pattern and/or the desired optical through-put to be achieved and, optionally, optimized. The alignment and attachment step is time consuming. Once the desired FAC lens alignment or position is achieved in the next part of operation 105 the lens is attached through any of a number of various attachment schemes.

One typical attachment scheme includes, but is not limited to, gluing the FAC lens to the submount or to a surface adjacent to the submount. The process of gluing the FAC lens to the submount is time consuming and requires skill since the optical power and beam pattern must be monitored throughout the cure process, with corrections being made by a skilled operator to compensate for movement of the FAC lens while the glue (e.g., the epoxy) cures. Alternatively, the process of gluing the lens to the submount requires sophisticated automated equipment to achieve the desired optical power and beam pattern and the process still remains time consuming.

Once the FAC lens is aligned and attached the lensed diode laser chip on the submount is tested in the Post Lens test (LIV, WL), which is operation 106. The Post Lens test 106 is similar to that described earlier for the CoS test (in operation 104), except now the optical power coupled through the lens is measured to assess lens coupling efficiency. Thus, the Post Lens test 106 measures the optical power coupled through the lens, the voltage and the wavelength as a function of electrical current. This operation can be manual, automated, or a combination of manual and automated.

In accordance with one embodiment, the typical process time to perform the actions of Station 4A, namely the active optical alignment and attachment (e.g., gluing) of the FAC lens directly to the submount (e.g., operation 105) and the post lens test (e.g., operation 106), takes a relatively long period of time. The takt time for station 4A is on the order of about 15 minutes and the operation can require operator intervention during the attachment (e.g., gluing and curing) time in order to correct the FAC lens during the cure process. In addition, because of the operator skill involved in attachment (e.g., by gluing), the amount of waste generated because of missed corrections can vary from operator to operator.

In accordance with currently available manufacturing techniques, once the FAC lens is attached to the submount, the lensed diode laser chip on the submount (e.g., the lensed CoS) is attached into an enclosure at station 6A during operation 108. Operation 108 requires a takt time of about 0.3 minutes. The enclosure provides a housing that houses the lensed diode laser chip on the submount such that these components are maintained within proximity to one another and are protected from the external environment from within the enclosure. The enclosure provides mechanical stability and/or support to the lensed diode laser chip on the submount. In addition, the enclosure can be a heatsink (e.g., labeled HS). Suitable materials that may be employed to fabricate the enclosure include, but are not limited to, for example, copper, WCu, or other materials having high thermal conductivity.

In some embodiments, operation 107 occurs in a station 5A and prior to operation 108. In operation 107 an electrode is attached to the enclosure (e.g., the heatsink labeled HS). The electrode can be attached to the enclosure by, for example, soldering. The electrode provides the electrical connectivity to other parts of the system, for example, the power supply, test station, or other control system. Suitable electrodes include, for example, thick film ceramic and/or a printed circuit board (e.g., a pcb board) with metal traces that are suitable for the required current level (e.g., a current level of from about 0.1 Amps to about 5 Amps, or the current level required to power the desired laser diode). Operation 107 requires a takt time of about 0.3 minutes.

In station 7A operation 109 is conducted in which the enclosure is wirebond. In this operation, the lensed diode laser chip on the submount (e.g., the lensed CoS) is electrically connected to the electrode. The takt time for station 7A is about 0.3 minutes.

In some embodiments, in station 8A and 9A during operations 110 and 111, the bare optical fiber is cleaved (in operation 110), and then attached to a ferrule assembly (by operation 111), respectively. Station 8A is where the optical fiber is prepared by being cleaved and the takt time required to complete operation 110 is about 1 minute.

Referring again to FIG. 1, in one embodiment, during operation 111 in station 9A a mechanism that imparts rigidity to the cleaved optical fiber and that enables the optical fiber to be attachable is added to the optical fiber.

In one embodiment, in operation 111, the cleaved optical fiber is attached to a ferrule assembly (e.g., the optical fiber is attached within the ferrule). The ferrule acts a mechanical support for the optical fiber; the ferrule holds the optical fiber and enables the optical fiber to be fixed in the desired position. The optical fiber may be glued into (e.g., epoxy glued into) and/or soldered into the ferrule. Where epoxy attachment of the fiber to the ferrule assembly takes place during operation 111 the operation has a takt time of about 5 minutes.

In station 10A Fiber Coupling and Test is conducted. In station 10A during operation 112 the fiber pigtail is aligned and attached. Operation 112 includes active alignment prior to attachment. The fiber within the ferrule assembly may be attached by any suitable means including, for example, laser welding, solder reflow and epoxy gluing.

During active alignment some current is provided to the laser diode chip to electrically operate the device so that it produces light and the fiber is adjusted to maximize the light throughput through the fiber. The fiber pigtail helps to transfer the optical energy from the laser diode chip to the outside world (e.g., to other parts of the system or device).

Like the lens attachment method described above in association with operation 105, active monitoring of the optical power is required, with constant adjustments to the optical fiber position as the attachment method is accomplished (e.g., the epoxy glue cures). Generally, the time required for any of these common optical fiber attachment methods (e.g., laser welding, solder reflow and epoxy gluing) is on the order of from about 15 minutes to about 20 minutes.

The optical fiber may be aligned with the lensed diode laser chip in accordance with a process similar to the above-described alignment of the FAC lens to the diode laser chip. More specifically, the process of alignment of the optical fiber with the lensed diode laser chip can be actively performed while the diode laser is operating to enable the optical power to be monitored to ensure and/or to maximize optical coupling. Alignment of the optical fiber can be achieved while employing any of a variety of fiber attachment methods with each fiber attachment method requiring different fiber preparations. Suitable fiber attachment methods include, but are not limited to: laser welding, solder reflow and epoxy gluing of the ferrule that contains the optical fiber therein. Here the ferrule acts as an attachment device that is attached to the base on which the optical fiber sits. The ferrule is attached to the base and to the optical fiber to provide the optical fiber with support. The ferrule provides the mechanism to hold the fiber, attach the fiber and align the fiber. The ferrule's rigidity aids in alignment and fixation of the optical fiber with the underlying support structure.

During operation 112, solder reflow may be employed for attachment of the ferrule containing the fiber. During solder reflow, a solder platform is required to attach the optical fiber thereto. The choice or selection of solder is limited by the glass transition temperature of the fiber cladding and/or by the glass transition temperature of the buffer. Optionally, solder reflow can be reinforced and/or further supported by an additional gluing operation whereby additional glue and/or epoxy are added to the top of the fiber to the ferrule assembly to help reinforce the position.

Laser welding may be employed during operation 112 for attachment of the fiber. In laser welding a specialized platform is employed to weld the fiber to a weld clip, the weld clip is used to hold a ferrule, and the ferrule is used to support the optical fiber. The weld clip can be welded to the specialized platform.

Operation 111 can avoid the use of a ferrule and instead include adding a metallization to the external surface of the cleaved fiber. Where a portion of the external surface of the optical fiber is metallized this takes place prior to operation 112. In operation 112 the metallized fiber is aligned and the metallized fiber is attached via soldering. Operation 111 can also avoid the use of a ferrule and instead include disposing glue on the external surface of the fiber such that during operation 112 the fiber is aligned and is attached directly using the glue.

Thereafter, in operation 113 the post fiber test is conducted whereby coupling through the optical fiber is assessed. In addition, as described in the tests conducted in operations 104 and 106 the test can also assess the optoelectronic characteristics for the given device including the optical power, voltage and wavelength, which are measured as a function of electrical current. The test in operation 113 can be manual, automated, or a combination of the two. The Fiber Coupling and Test of station 10A has a takt time of about 15 minutes.

Once the lensed diode laser chip is aligned with the optical fiber, the remaining manufacturing steps include lid attach and seal (at station 11A) and then a final test (at station 12A). These remaining manufacturing steps are typical and well understood by people knowledgeable in the field of photonics module assembly. For example, referring still to FIG. 1, in station 11A Lid Attach and Sealing is conducted during operation 114. The lid may be made from plastic and/or metal and can be glued or soldered respectively. Operation 114 includes Lid Attachment and Sealing and the takt time is about 1 minute. Station 12A, includes operation 115 in which the final test is conducted. In the final test the optical power coupled through the lens, the voltage, the wavelength and coupling through the optical fiber are measured as a function of electrical current. The test in operation 115 can be manual, automated, or a combination of the two. The takt time of operation 115 is about 1 minute.

Referring again to FIG. 1 the 15 operations of the prior art photonics module require 12 stations, 2 wirebond operations, 2 active alignment steps, and 4 test operations all of which require about 43 minutes of sequential takt time.

### SUMMARY OF THE INVENTION

It is desirable to design a photonics module that is suitable for application in a device having a lower price point relative to current devices that incorporate photonics module(s). It is desirable that this lower cost photonics module achieves relatively high optical power (greater then 1 W, greater than 0.5 W, or from about 0.5 W to about 20 W, or greater than 20 W) with minimal optical coupling loss (e.g., an optical coupling loss that is less than about 15%, or less than about 12%, or less than about 10%, or less than about 5%). It is desirable for a lower cost photonics module(s) to have one or more of, fewer parts less bill of material (BOM), a lower cost of bill of material (cBOM) and/or a lower manufacturing cost (e.g., a lower cost manufacturing process and/or a lower cost apparatus for assembly of a photonics module).

In one embodiment, the photonics module can include a motherboard and an enclosure having a base onto which the motherboard can be mounted. The motherboard can include a laser diode disposed thereon and a channel configured to receive an optical fiber to be aligned with the diode. The enclosure can also include a plurality of spaced-apart positioning elements for engaging the motherboard in a desired position within the enclosure. Further, the enclosure can define a volume sufficient to sequester excess mounting material from the motherboard.

Positioning portions may also be referred to as positioning elements and likewise positioning elements may be referred to as positioning portions. The positioning elements can take a variety of forms. In one embodiment, the plurality of spaced-apart positioning elements extend from the base. For example, the positioning elements can be columns or can be portions of an enclosure wall. For example, the motherboard can be disposed within a cavity defined by the base and one or more sidewalls. The sidewalls of the cavity can extend from the base and can include a plurality of spaced-apart positioning elements which form or extend from the sidewalls. The space between and/or adjacent to the plurality of positioning elements can be configured to receive the mounting material (e.g., at least some excess mounting material) when the motherboard is mounted onto the base. The space adjacent to and/or between the plurality of sidewalls can be configured to prevent the mounting material from contacting at least one of a side or a top of the motherboard.

The channel of the motherboard can also have a variety of configurations. In one aspect, the channel can provide passive alignment of the optical fiber and the emission of the diode such that an optical fiber is automatically aligned with the diode when the optical fiber is disposed within the channel. The channel can be a v-groove, a half-pipe, or have any other cross-section, for example, and can be disposed along a major or minor dimension of the motherboard. The motherboard can also include additional channels, for example, a second channel that is configured to receive and align a lens such that the lens is disposed between the diode and the optical fiber. The second channel can have a lens disposed therein such that the lens transmits emission of the diode into the optical fiber. The second channel can, for example, extend along a major or minor dimension of the motherboard.

In one aspect, a photonics module includes a motherboard having a channel configured to receive an optical fiber and to align the optical fiber with a laser diode emission. The motherboard may be, for example, a Silicon motherboard. The photonics module includes an enclosure having two or more positioning elements that locate the motherboard in a desired position within the enclosure. The enclosure has a base portion and the two or more positioning elements that are spaced from one another such that mounting material disposed between the enclosure base portion and the bottom of the motherboard wicks into a space adjacent a positioning element (e.g., at least some excess mounting material is sequestered into a space of a volume adjacent a positioning portion). In some embodiments, the enclosure is a heat sink. Optionally, the two or more positioning elements engage and/or maintain the motherboard in substantially the desired position within the enclosure. In some embodiments, the photonics module further comprises a lid that covers a surface of the enclosure to protect contents disposed within the enclosure. The enclosure may have a substantially flat base portion.

In one embodiment, the motherboard further comprises another channel configured to hold a lens and the lens and the optical fiber optically align with the laser diode emission when held by their respective channel(s).

The channel can be, for example, a v-groove sized to hold an optical fiber such that the optical fiber optically aligns with a laser diode emission when held by the v-groove. In one embodiment, the motherboard further comprises another v-groove sized to hold a lens and the lens and the optical fiber optically align with the laser diode emission when held by their respective v-groove(s).

In other embodiments, the optical fiber itself includes a lens, such that the lens is part of the optical fiber.

In some embodiments, a laser diode (e.g., a laser diode chip) is disposed on a top surface of the motherboard. Optionally, the laser diode itself can include a lens such that the lens is part of the optical fiber.

Suitable lenses may be, for example, collimating lenses or, for example, focusing lenses.

In one embodiment, the optical fiber has a numerical aperture (NA) that is greater than or equal to about 0.48. Where the optical fiber has a NA that is greater than or equal to about 0.48 then use of a lens may be unnecessary. In some embodiments the laser diode chip has a relatively low divergence (e.g., less than 15°). In another aspect, a photonics module includes a laser diode disposed on a top surface of a Silicon motherboard. The Silicon motherboard includes a plurality of v-grooves, a lens for collimating a laser diode emission, and an optical fiber. The Silicon motherboard includes one v-groove sized to hold the lens and another v-groove sized to hold the optical fiber. The lens and the optical fiber optically align with the laser diode emission when held by their respective v-grooves. An enclosure includes two or more positioning portions that locate the Silicon motherboard in a desired position within the enclosure. The enclosure has a base portion and the two or more positioning portions that are spaced from one another such that mounting material disposed between the enclosure base portion and the bottom of the Silicon motherboard wicks into a space adjacent at least one positioning portion. In one embodiment, the mounting material wicks into a space between the two or more positioning portions.

In some embodiments, the space adjacent at least one positioning portion and/or the space between the two or more positioning portions enables the mounting material to avoid contacting at least one of the sides of the Silicon motherboard and the top of the Silicon motherboard. In some embodiments, a positioning portion is a portion of an enclosure wall. In other embodiments, a positioning portion is a column.

Suitable positioning portion columns can have any of a number of cross sectional shapes (e.g., circle, triangle, quadrilateral (i.e., square, rectangular), pentagon, hexagon, heptagon, octagon or any other suitable polygon that provides the desired characteristics to the enclosure). In one embodiment, one v-groove is disposed along the major flats (e.g., the major dimension) of the Silicon motherboard and another v-groove is disposed along the minor flats (e.g., the minor dimension) of the Silicon motherboard. In one embodiment, each of the lens and the optical fiber are attached within their respective v-groove by one or more of an epoxy, a solder, or combination thereof.

The photonics module may desirably include a lid that covers a surface of the enclosure and the lidded enclosure protects the contents disposed within the enclosure from the surrounding environment. Optionally, the enclosure has a substantially flat base portion.

The positioning portions within the enclosure locate and guide the silicon motherboard and/or the electrical board to a desired position within the enclosure. The positioning portions can provide stability such that the parts (e.g., the Silicon motherboard and/or the electrical board) held within the enclosure are maintained in a substantially stable position (e.g., the contents of the enclosure do not rotate, shift, or move) and the desired alignment of the Silicon motherboard and/or the electrical board is maintained.

The positioning portions within the enclosure locate and guide the Silicon motherboard and/or the electrical board to the desired position (e.g., a recess and/or a slot) where the Silicon motherboard and/or the electrical board are disposed with the aid of the positioning portions that guide them into place.

In another aspect, a method of making a photonics module includes providing a Silicon motherboard having a plurality of v-grooves, disposing a laser diode on a top surface of the Silicon motherboard, and placing a lens in a lens v-groove disposed along the minor flats and sized to hold the exterior dimensions of the lens. The method also includes placing an optical fiber in an optical fiber v-groove disposed along the major flats and sized to hold the exterior dimensions of the optical fiber. The lens and the optical fiber optically align with the laser diode emission emitted from the laser diode when held by their respective v-grooves. The method also includes disposing the Silicon motherboard in an enclosure having two or more positioning portions that locate the Silicon motherboard in a desired position within the enclosure. In one embodiment, the laser diode is disposed on the top surface of the Silicon motherboard prior to providing the Silicon motherboard. The method can optionally include the step of cleaving the optical fiber from a bare fiber prior to placing the optical fiber in the optical fiber v-groove.

The method can also optionally include the step of disposing an electrical board in the enclosure. In some embodiments, the Silicon motherboard and the electrical board are disposed in the enclosure substantially simultaneously.

### DETAILED DESCRIPTION OF THE FIGURES

FIG. 1 is a manufacturing process flow of a presently available photonics module.

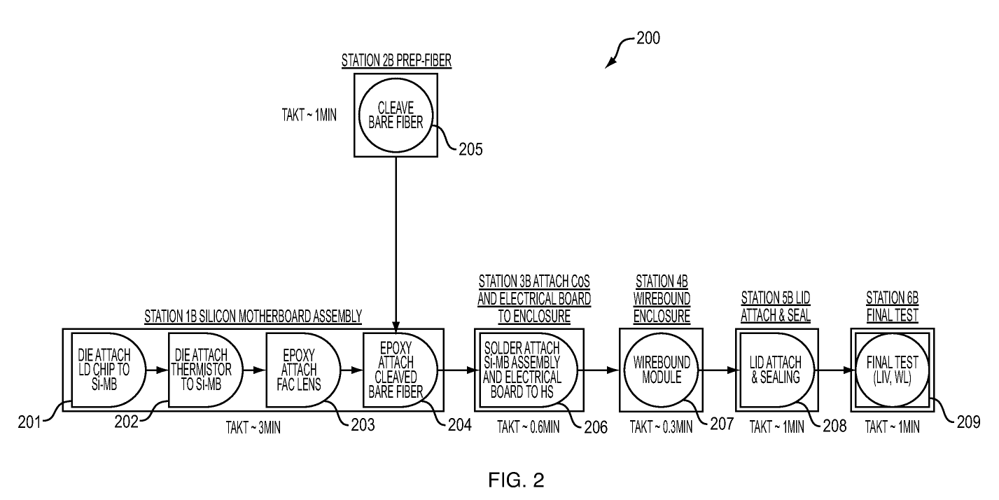

FIG. 2 is a manufacturing process flow of a photonics module that employs one or more innovations disclosed herein.

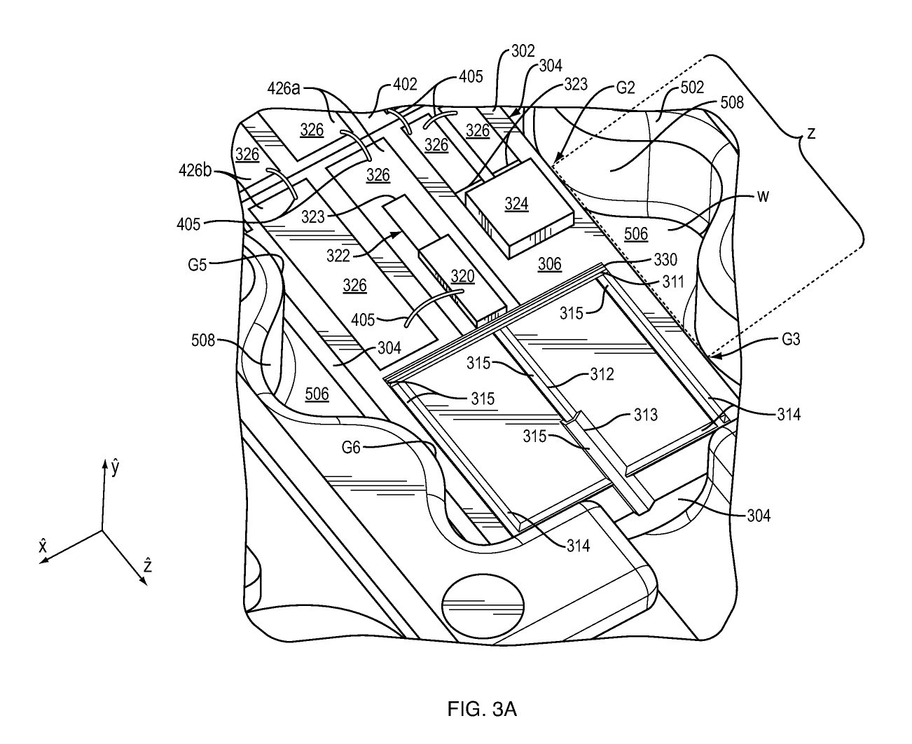

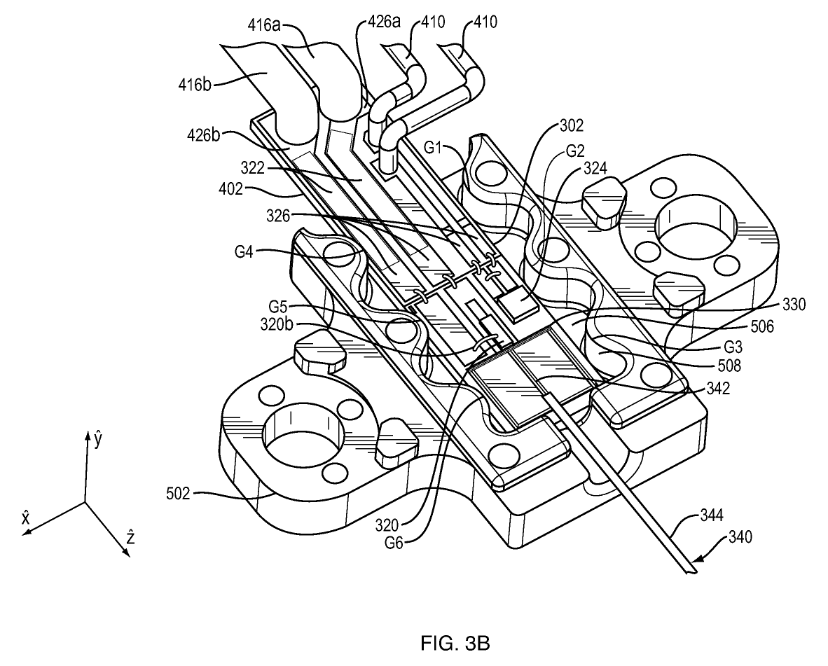

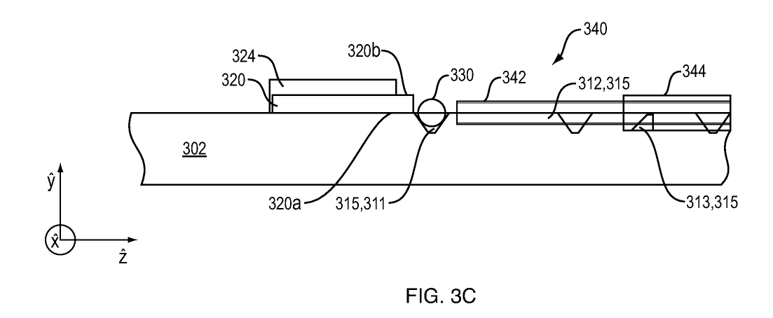

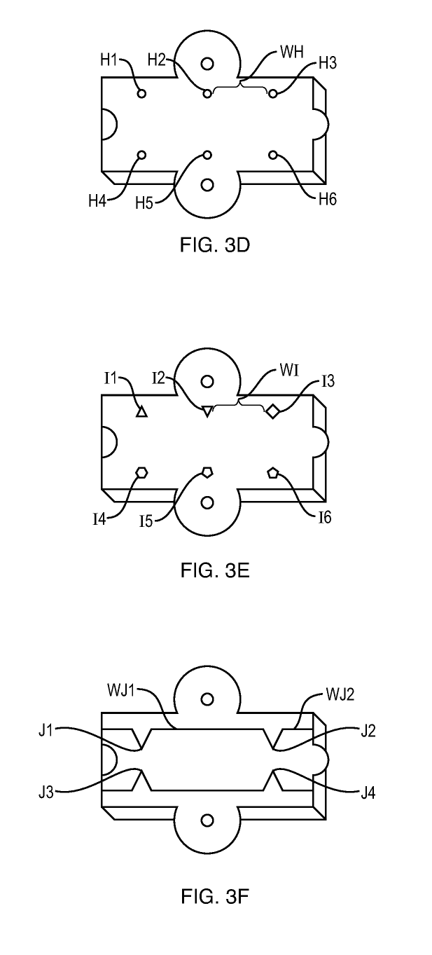

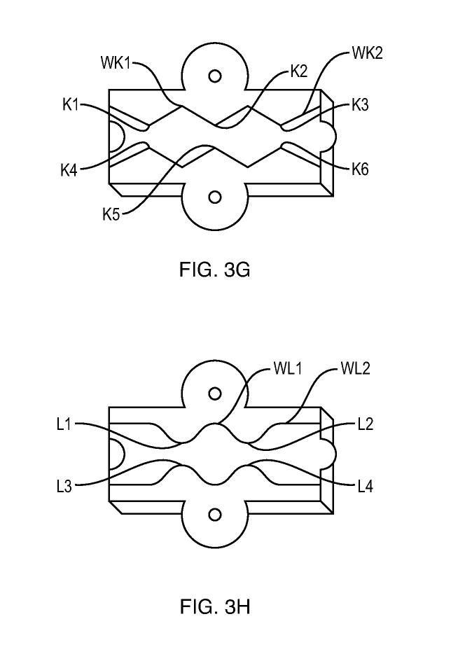

FIG. 3A shows a Silicon motherboard that has a plurality of v-grooves and supports a laser diode and a thermistor and an electrical board, both the Silicon motherboard and the electrical board are disposed in the enclosure, which acts as a heat sink.

FIG. 3B shows a Silicon motherboard assembly (a Silicon motherboard that has a plurality of v-grooves and supports a laser diode, a thermistor and an optical fiber) and an electrical board, both the Silicon motherboard assembly and the electrical board are disposed in the enclosure, which acts as a heat sink.

FIG. 3C shows a side view of a cross section through the Silicon motherboard assembly that includes the laser diode, the lens disposed in the lens v-groove, and the cleaved portion of the optical fiber disposed in the optical alignment v-groove, and the uncleaved portion of the optical fiber disposed in the buffer v-groove.

FIG. 3D shows another embodiment of an enclosure, the enclosure having positioning portions that are columns, each column H1, H2, H3, H4, H5, and H6 having a substantially circular cross sectional shape.

FIG. 3E shows another embodiment of an enclosure, the enclosure having positioning portions that are columns with each column I1, I2, I3, I4, I5, and I6 having a polygon cross section.

FIG. 3F shows another embodiment of an enclosure, the enclosure walls have two or more portions that are positioning portions, specifically substantially triangular shaped positioning portions J1, J2, J3 and J4.

FIG. 3G shows another embodiment of an enclosure, the enclosure walls have two or more portions that are positioning portions, specifically substantially triangular shaped positioning portions K1, K2, K3, K4, K5 and K6.

FIG. 3H shows another embodiment of an enclosure, the enclosure walls have two or more portions that are positioning portions, specifically substantially curved positioning portions L1, L2, L3, and L4.

FIG. 4 shows a side view of the optical system of the Silicon motherboard assembly including the laser diode, the lens, and the optical fiber in optical alignment. The output end of the laser diode has an alignment distance (A) from an external surface of the lens and the lens has an alignment distance (B) from the closest end of the optical fiber.

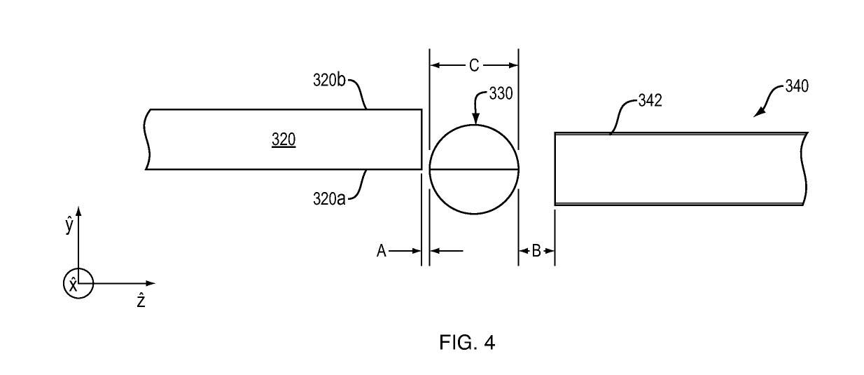

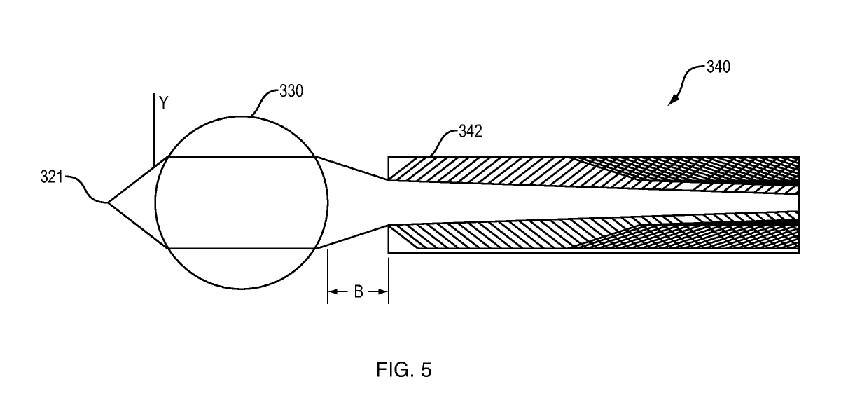

FIG. 5 shows a raytrace that simulates the coupling of light emission from the laser diode through the lens and the optical fiber as depicted from the side of the optical system shown in FIG. 4.

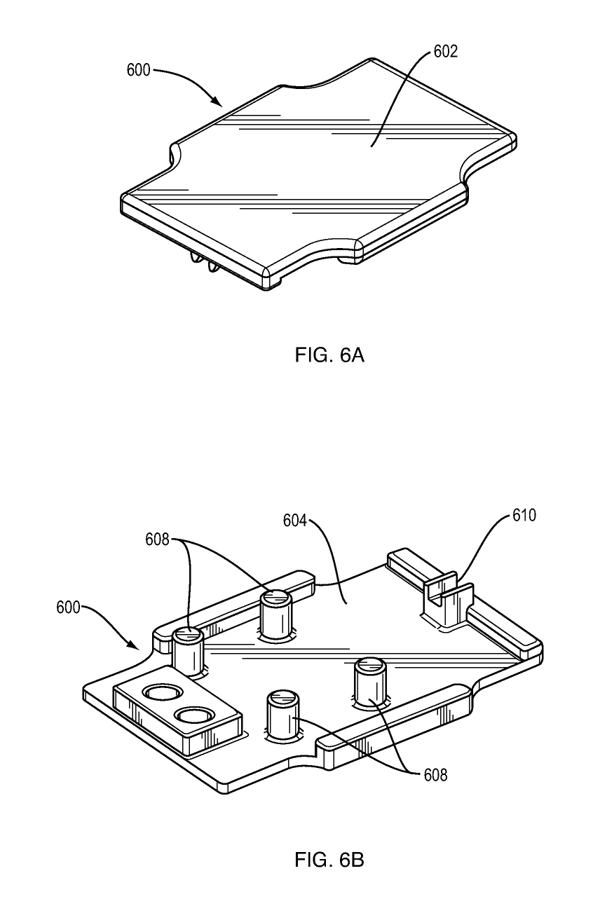

FIG. 6A shows a top view of a lid adapted for attachment to an enclosure that contains a Silicon motherboard assembly.

FIG. 6B shows a bottom view of a lid adapted for attachment to an enclosure that contains a Silicon motherboard assembly.

### DETAILED DESCRIPTION

The ability to achieve a lower cost photonics module, relative to the cost of currently available photonics module(s), relies at least in part on a design that reduces the number of component parts that make up a photonics module. Alternatively or in addition, the ability to achieve a reduced cost photonic module relative to currently available photonics module(s) relies on a design that reduces the number of manufacturing steps, has a reduced amount of time required for manufacture of the photonics module (e.g., a reduced takt time), and/or a reduced amount of manufacturing equipment required to produce the module. In particular, the ability to achieve a reduced cost photonic module is enabled by one or more of the elimination of active alignment for the FAC lens and/or the optical fiber, a reduced number of component parts and a reduced number of manufacturing steps which achieve the same or better performance compared to currently available photonic modules which in one exemplary embodiment are assembled according to the processes described in association with FIG. 1.

In addition to the number of manufacturing steps, the time for each unit operation in the manufacturing operation also impacts the cost of photonics module production. The impact of time of each unit operation is particularly important when a relatively large production volume is desired, because when more volume is needed, additional equipment may be required to keep up with the volume. Therefore, it is desirable that a manufacturing process has a relatively fast output through a streamlined process that avoids unnecessarily time intensive steps and avoids any steps that that can be eliminated, such that additional manufacturing equipment may be avoided.

TABLE 1
Operation takt time for any one operation required to achieve weekly
production volume goals as a function of the number of production
hours per week

| | Takt time to achieve the desired weekly volume | | | |
|---|---|---|---|---|
| | 1 shift/day | 2 shifts/day | 3 shifts/day | 3 shifts/day |
| desired | 5 days/week | 5 days/week | 5 days/week | 7 days/week |
| volume | 7 hours/shift | 7 hours/shift | 7 hours/shift | 7 hours/shift |
| 30,000 | 3.50 | 7.00 | 10.50 | 14.87 |
| 100,000 | 1.05 | 2.10 | 3.15 | 4.46 |
| 300,000 | 0.350 | 0.70 | 1.05 | 1.49 |
| 700,000 | 0.150 | 0.30 | 0.46 | 0.64 |
| 1,000,000 | 0.11 | 0.21 | 0.32 | 0.45 |

For example, referring to Table 1, the capacity of a given operation is limited by its takt time for that operation. Therefore, capacity of a complete production process is limited by the operation with the largest takt time. From the process shown in FIG. 1, the largest takt time is about 15 minutes, which is a length of time that would make a volume of 30,000 impossible to achieve even if three shifts of seven hours per shift were employed seven days per week. As Table 1 illustrates, reducing the takt time for the process can be critical to achieving high volumes that would be required to commercialize a photonics module on a large scale.

In one embodiment, an improved photonics module has a reduced number of components required for its production compared to previously known photonics modules (e.g., the total number of components to produce the improved photonics module is fewer than the total number of components to produce previously available photonics modules).

In another embodiment, an improved photonics module is produced by a process that reduces the total number of manufacturing steps required to bring the diode laser chip together with both the FAC lens and the optical fiber. Optionally, an improved photonics module is produced by a process that eliminates one or more manufacturing steps required to align the diode laser chip together with both the FAC lens and the optical fiber.

In still another embodiment, the requirement for the active alignment of the FAC lens and/or the optical fiber is eliminated. Referring again to FIG. 1, alignment of the FAC lens at operation 105 and alignment of the optical fiber at operation 112 occur in stations 4A and 10A, both of which require the largest takt time, about 15 minutes. Elimination of a requirement for active alignment can be accomplished by utilizing the crystallographic properties of silicon semiconductor material. More specifically, silicon semiconductor material has a diamond cubic structure with known preferential planes. The preferential planes of the silicon semiconductor material can be used to form well defined surfaces (e.g., channels and/or v-groove shaped feature(s)) that can be utilized for the alignment of optical components. Elimination of active alignment reduces the number of manufacturing steps required to manufacture a photonics module, because it eliminates active alignment of the FAC lens (operation 105) and/or eliminates active alignment of the optical fiber (operation 112). Elimination of active alignment significantly reduces the takt time required for positioning (e.g., aligning) and attaching the optics and locating them in the desired position (e.g., the preferred position or the optimal position).

FIG. 2 provides a Photonics Module Manufacturing Process Flow 200 that incorporates at least some of the innovations described herein. The process flow shown in FIG. 2 reduces the total number of operations, the total number of stations, the number of wirebonding operations, and the total number of test operations relative to the process flow shown in FIG. 1. In addition, the process shown in FIG. 2 eliminates the need for any active alignment steps. As a result, the Photonics Module Manufacturing Process Flow shown in FIG. 2 has a significantly lower total takt time than the Prior Art process described in connection with FIG. 1.

Referring again to FIG. 2, in Station 1B a Silicon motherboard Assembly is formed by providing a Silicon motherboard that features one or more channels and attaching a laser diode chip (operation 201), a thermistor (operation 202), an FAC lens (operation 203) and a cleaved bare fiber (operation 204) to the Silicon motherboard featuring the one or more channels. Referring now to FIG. 3A, in order to form a Silicon motherboard 302 one or more channels 315 are etched into at least a portion of a silicon wafer.

The channels can have a variety of configurations. In one embodiment, v-groove feature(s) 315 are achieved by orientating a silicon wafer in a desired direction and etching the desired location for the optics of the silicon wafer via masking and chemical etching. More specifically, the silicon wafer, having a thickness that ranges from about 500 microns to about 1000 microns, is oriented such that the v-groove channels 315 are aligned in the direction of the major flats and/or the minor flats of the silicon wafer. More specifically, in one embodiment, the lens v-groove 311 is etched along the direction of the minor flat of the Silicon wafer whereas the optical alignment v-groove 312, the buffer v-groove 313, and the wicking v-groove 314 are all etched along the direction of the major flat of the Silicon wafer. Optionally, one or more wicking v-grooves 314 can be etched along the direction of the minor flat. Aligning the v-groove along the respective orientations (e.g., along the major flats and the minor flats) enables the v-groove shape to be achieved via chemical etching.

Where silicon wafer chemical etching is employed, the alignment tolerances that can be achieved are on the order of a few microns and hence are well suited for the application. This precision is possible because v-groove(s) 315 are formed at the crystal level of the Silicon and because the crystal lattices are well defined and precise. Any slight deviation in the v-groove(s) are an artifact to the step of masking the silicon wafer to define the location of the v-groove and deviation tolerances can be held within a couple of micrometers (e.g., from about 2 or about 3 micrometers, for example). More specifically, alignment features and/or v-groove 315 formations can be formed in the silicon wafer by wet chemical etching of exposed surfaces that are preferentially masked with a layer that can resist the etchant.

Suitable etching chemicals that may be employed to etch the Silicon wafer include, for example, Potassium Hydroxide (KOH), and suitable masking agents can include, for example, Silicon dioxide (SiO₂), which is capable of resisting the etchant. The unmasked portions of the silicon wafer are exposed to the chemical etchant. The formation of the v-groove 315 occurs as a result of chemically etching the dangling pairs of electron bonds present on the exposed surfaces of the silicon wafer. The etching continues through the surfaces of the silicon wafer until the etching chemical encounters a surface lacking these dangling pairs of electron bonds. The surface lacking the dangling pairs of electron bonds is defined as the (1 1 1) surface of the crystal structure that does not have dangling pairs of electrons and hence is resistant to the chemical etchant, which limits further etching through the surface (e.g., the y-direction as shown in FIGS. 3A and 3B) of the silicon wafer and hence creates the formation of a v-groove feature. The shape and size of the v-groove is defined by the opening(s) in the masking layer.

The v-groove has a desired tolerance that ranges from about 2 or about 3 micrometers. The v-groove tolerance is obtained as a result of a combination of the mask definition and the properties of the silicon crystal itself. The v-groove formed in the silicon enables passive optical alignment of, for example, the FAC lens and the optical fiber.

Optionally, referring still to FIG. 2 the silicon motherboard provided in operation 201 is in the form of a silicon motherboard that is manufactured in accordance to standard silicon wafer processing. The silicon motherboard can have other metallizations (e.g., metalized trace(s)) for mounting other components such as, but not limited to, diode laser chip, thermistor, etc. Additionally the microbench can have electrical traces to facilitate electrical connectivity. The metallizations can be designed to facilitate and improve thermal heat sinking performance.

In one embodiment, referring now to FIG. 3A, the silicon motherboard 302 has one or more metallization on the top 306 and/or the bottom of the silicon substrate. The metallization(s) can be, for example, gold. The metallization should be both solderable and Au wire bondable. In one embodiment, the metallization has a base layer of Ti, a second layer of Pt and a third layer of Au, each of the layers can range in thickness from about 500 Angstroms to about 8000 Angstroms, or from about 1000 Angstroms to about 5000 Angstroms. Suitable metallization(s) must withstand a temperature of about 425° C. for about 15 minutes without peeling and/or blistering. The one or more metallization may be in the form of one or more metalized trace 326 disposed on the top 306 of the silicon motherboard 302.

The solder used for mounting the laser diode chip and the thermistor 324 can be a pre-deposited on the silicon motherboard 302. More specifically, the pre-deposited solder 323 may be deposited on top of the metallization (e.g., the metalized trace 326) located on the top side 306 of the silicon motherboard 302. The pre-deposited solder 323 may be, for example, 80Au20Sn. In one embodiment, the pre-deposited solder 323 is disposed on top of a solder barrier 322 (e.g., a Pt layer) that separates and isolates the pre-deposited solder 323 from the underlying metallization layer (e.g., an Au layer or a metalized trace 326).

In one embodiment, the metallization base layer is Au (e.g., a metalized trace 326), the second layer is the solder barrier layer made from Pt, which is about 1500 Angstroms thick, and the third layer is the solder layer made from 80Au20Sn, which is from about 3 to about 7 microns thick. Each metallization trace 326 (e.g., each Au pad region) can be electrically isolated from another metallization trace 326 either by using a non-electrically conductive Silicon (typically about 500 microns thick), or by using a separate underlying insulating layer. The separate underlying insulating layer should not be too thick. Thicknesses that inhibit thermal transfer of the heat generated by the laser diode through the Silicon motherboard 302 should be avoided. Suitable thicknesses of underlying insulating layers range from about 300 Angstroms to 5000 Angstroms.

Silicon has a thermal conductivity that ranges from 130 W/m-K to 180 W/m-K, or about 150 W/m-K. Surprisingly, the thermal conductivity of silicon is lower then the thermal conductivity of the typical materials used for heat sinking of diode lasers. Typical materials used for heat sinking diode lasers include but are not limited to BeO, WCu, and Cu, which have a thermal conductivity that ranges from about 150 W/m-K to about 400 W/m-K. Such typical heat sinking materials are utilized in currently available high optical power devices made according to currently available techniques that are described in the background of the invention and in association with FIG. 1.

However, since the thickness of the silicon is on the order of 500 microns and metallization can be applied as a part of the fabrication an overall lower thermal resistance is created according to the techniques disclosed herein than is created when fabricating the currently available photonics modules (e.g., photonics modules that require active alignment during fabrication as are described in association with FIG. 1). Devices mounted on the typical materials that are used in the presently available high optical power devices typically have a thermal resistance of from about 10 W/K to about 13 W/K. In contrast, at least in part because of the thickness of the motherboard and the metallization employed, the improved photonics module employing the v-groove can have a thermal resistance from between about 5 W/K and about 7 W/K. Hence, a significant improvement in optical power is attained because of the lower thermal resistance present in the improved photonic module employing the v-groove (e.g., from between about 5 W/K and about 7 W/K) relative to presently available photonic modules featuring active alignment (e.g., from about 10 W/K to about 13 W/K).

Referring again to FIGS. 2 and 3A, in Station 1B the silicon motherboard 302 has metallization (e.g., an Au metallization or a metalized trace 326) on the top 306 of the silicon substrate. In some embodiments, the metallization(s) (e.g., the metalized trace(s) 326) do not overlap the v-groove 115. In FIG. 2 during operation 201 a laser diode 320 is die attached to a pre-deposited solder 323 located on a metalized trace 326 on the top of the silicon motherboard 302.

The laser diode 320 that is attached in operation 201 can be, for example, a laser diode chip. The laser diode chip can be, for example, a high power single emitter multimode semiconductor laser diode, a high optical power multimode semiconductor laser diode or it can be a multi-emitter chip in the form of an array. The array can be as large as, but is not limited to, 10 mm wide and have two emitters or more than two emitters. In one embodiment, the laser diode chip is labeled to enable differentiation of its AR (e.g., the Anti-Reflection Coated side) from its HR side (e.g., the High Reflection Coated side). The laser diode chip can have a chip width of from about 400 μm to about 12 mm and the chip length (cavity length) can be from about 500 μm to about 5000 μm. The thickness or depth of the laser diode can be from about 50 μm to about 500 μm. In one embodiment, the laser diode chip is die attached, with the p-side facing down (e.g., the anode-side facing down), to the top 306 of the silicon motherboard 302. The die attach metallization can include a solder (e.g., a pre-deposited solder 323) such as, for example, an 80Au20Sn solder, other suitable solders include, but are not limited to AuGe, other alloys of AuSn, Sn, SnAg, etc. In one embodiment, mounting the laser diode 320 anode-side (p-side) facing down onto the silicon motherboard 302 utilizing 80Au20Sn solder supports the requirements for delivering high optical power. In one embodiment, the pre-deposited solder pad 323 for the laser diode is sized to enable at least some future size change of the laser diode 320, more specifically; the solder pad 323 for the laser diode 320 can have a larger width and/or a longer length than the projected chip size. In one embodiment, the solder pad 323 has dimensions that range from about one time to about three times the projected laser diode chip dimensions.

In one embodiment, a flux-free mounting process is used to minimize and/or avoid contamination and/or damage to the emitting facet. In one embodiment, the die attached laser diode is capable of delivering high optical power. For example, the die attach metallization (e.g., the metalized trace 326) should support up to 5 Amps of operating current to the laser diode 320. In one embodiment, the die attach metallization supports delivery of up to 5 Amps or up to 10 Amps of operating current to the laser diode 320.

Referring still to FIG. 3A, optionally, the silicon motherboard 302 supports a sensor 324 (e.g., a temperature sensor such as a thermistor) mounted on the top side 306 of the Silicon mother board 302, e.g., to a metallization (e.g., a metalized trace 326) present on the top 306 of the Silicon motherboard 302 surface. Referring also to FIG. 2 in operation 202 a thermistor 324 is die attached to the silicon motherboard, more specifically, the thermistor 324 is die attached to a pre-deposited solder 323 located on a metalized trace 326 on the top of the silicon motherboard 302. The thermistor 324 is a temperature sensor, more specifically, a thermistor 324 is a resistor whose resistance varies according to its temperature. The thermistor 324 provides a mechanism to monitor the temperature of the Silicon motherboard 302 to enable temperature monitoring and control of the photonics module.

The thermistor 324 has a resistance range capable, but not limited to, sensing a temperature of from about 0° C. to about 80° C., or about 10K. Suitable thermistors are available from Betatherm including serial number PN#10K3CG3. Such a thermistor is suitable for wirebonding with, for example, Au.

Referring now to FIGS. 2 and 3A-3C, in operation 203 the FAC lens 330 is epoxy attached to the Silicon motherboard 302 assembly. One or more of the v-groove(s) 315 disposed in the silicon motherboard assembly is a lens v-groove 311 that enables the FAC lens 330 to be optically aligned with the laser diode 320 (e.g., the laser diode chip). In this way, the lens v-groove 311 provides a means for passive optical alignment of the light emission from the laser diode 320 to the FAC lens 330. Simply placing the FAC lens 330 within the v-groove 311 optically aligns the FAC lens 330 in a passive manner.

The FAC lens 330 can be, for example, a sapphire fast axis collimating lens fabricated from any of a number of materials including, for example, optical grade sapphire. Additional materials suitable for manufacturing the FAC lens could be, but are not limited to, other optical grade materials such as Fused Silica, Quartz, or plastic optical materials such as Zeonex COP materials. The optical grade sapphire material can have a c-axis random orientation. The FAC lens is used for coupling the light emission from the laser diode 320 to the optical fiber (described later in conjunction with operation 205 and FIGS. 3B and 3C). The selected FAC lens 330 should be chosen to optically couple while avoiding unnecessary transmission loss. For example, a desirable FAC lens 330 will maximize optical coupling and minimize transmission loss. In one embodiment, a FAC lens employs a sapphire rod type lens that has a substantially cylindrical shape (or a completely cylindrical shape), in another embodiment the sapphire rod type lens employed as a FAC lens is at least partially truncated such that rather than having a cross section of a circle the cross section resembles the letter “D.” Alternatively, multiple portions of the sapphire rod can be truncated (e.g., such that the cross section has two parallel sides connected to one another by a curve). Optical simulations can be employed to determine the desired lens shape and/or lens position. The FAC diameter can be, but is not limited to, between about 100 microns and about 300 microns and the length can be chosen to prevent clipping (e.g., blocking or truncating all or a portion of) the optical energy. Suitable lengths for the lens can be, but are not limited to, between about 100 microns to about 6 mm. In one embodiment, the FAC lens has a diameter of about 0.200 mm and a length of more than 1 mm. The diameter can be fixed, but the length can be extended as needed. All or a portion of the FAC lens can be coated with a coating that controls Fresnel losses (e.g., limits and/or minimizes Fresnel losses). For example, in one embodiment, an AR (anti-reflection coating) coats at least a portion of the FAC lens. The AR coating as deposited on the FAC lens should withstand an energy intensity of 1 KW/cm². The AR coating can be selected to have minimal to no reflection.

The AR coating should be selected in accordance with the wavelength range to be employed by the laser diode such that reflection is eliminated and/or minimized within the desired wavelength range emitted by the laser diode. The wavelength can range from about 360 nm to about 3000 nm, or from about 1390 nm to about 1430 nm, or from about 1200 nm to about 1600 nm, or from about 1460 nm to about 1480 nm.

Referring now to FIGS. 3A and 3B, one or more wicking v-grooves 314 are disposed in the Silicon motherboard 302. The wicking v-groove(s) 314 can accept any excess glue (e.g., epoxy gluing) or solder material that is employed to attach the various components to the Silicon Motherboard 302 assembly. Wicking v-grooves employed in the Silicon Motherboard 302 can ensure that the spread caused by excess glue and/or excess solder material does not get onto the optical components, get onto the laser diode and/or interfere with the optical beam.

Referring now to FIG. 2, station 2B involves optical fiber preparation, which includes operation 205 in which an optical fiber, (e.g., a bare fiber) is cleaved. Suitable optical fibers that can be employed in accordance with operation 205 include, for example, a large core multimode optical fiber (MMF). The takt time for preparing the fiber by cleaving is about 1 minute.

Suitable optical fibers can have a numerical aperture (NA) that ranges from about 0.1 to about 1.0, or greater than 0.2, or greater than 0.22. Suitable optical fibers include large core multimode optical fibers such as those available from Polymicro Technologies. Suitable optical fibers can have a fused silica core, a doped fused silica cladding surrounds all or a portion of the fused silica core and a buffer that surrounds all or a portion of the doped fused silica cladding. Suitable buffers include, for example, an acrylate buffer or a polyimide buffer, for example. The fiber should have low optical absorption, for example suitable fibers are of the low OH type (e.g., the low hydroxide type). One suitable fiber is for example a Silica optical fiber having an ultra low OH core. The physical dimensions of the optical fiber should be tailored to the v-groove dimensions to enable suitable passive alignment. In one embodiment, the fused silica core has a diameter that measures from about 100 microns to 1 mm or about 150 microns, the optical fiber has a cladding section that has a diameter that measures from about 105 microns to about 1.05 mm, or about 165 microns, the buffer has an outer diameter that measures from about 200 microns to 1.2 mm, or about 250 microns. During operation 205 cleaving the bare fiber can include removing at least a portion of the buffer from the outer diameter of the optical fiber to enable critical optical alignment. After cleaving, the optical fiber has a cleaved portion in which the core is surrounded only by a cladding section. Placement of the optical fiber into the v-groove can enable passive optical alignment with the photonics module. Referring now to FIGS. 3A-3C, both the cleaved portion 342 and the uncleaved portion 344 of the optical fiber 340 are placed in a v-groove 315. More specifically, the cleaved portion 342 is placed in the optical alignment v-groove 312 and the uncleaved portion 344 is placed in a buffer v-groove 313. The optical alignment v-groove 312 can enable optical alignment of the cleaved portion 342 of the optical fiber 340. The buffer v-groove 313 can enable mechanical support of the uncleaved portion 344 of the optical fiber 340.

Referring to FIGS. 2 and 3A-3C, in Station 1B, in operation 204 the bare optical fiber cleaved in operation 205 is epoxy attached to the v-groove 315 (e.g., the cleaved portion 342 is placed in the optical alignment v-groove 312 and optionally the uncleaved portion 344 is placed in the buffer v-groove 313). The takt time for the four operations (e.g., operations 201, 202, 203 and 204) that occur in station 1 is about 3 minutes. This Silicon motherboard 302 assembly process that occurs in Station 1 (operations 201, 202, 203 and 204) is adaptable to standard multilayer silicon wafer production processes, which are readily employed in, for example, the computer chip industry.

The Silicon motherboard 302 is constructed to contain features for the improved attachment of a diode laser 320 and optical components (e.g., a FAC lens 330 and an optical fiber 340). Suitable v-groove(s) 315 disposed in the silicon motherboard assembly 302 are capable of supporting a laser diode 320. In one embodiment, the diode laser 320 is mounted on top 306 of the Silicon motherboard 302 surface, e.g., to a metallization (e.g., a metalized trace 326) present on the top 306 of the Silicon motherboard 302. Features for diode laser attachment include, but are not limited to, providing features necessary for aligning a FAC lens 330 with an optical fiber 340 such that the FAC lens 330 and the optical fiber 340 are aligned with one another and optionally are aligned with one another simultaneously. Preferably, these features for the optical components (e.g., the FAC lens 330 and the optical fiber 340) can provide alignment tolerances within a few microns. It is possible to passively align and attach both the FAC lens 330 and the optical fiber 340. In this way, the skill and time heretofore required in currently available processes (as discussed with the description of FIG. 1) to actively align the FAC lens (in Station 4A, about 15 minutes) and actively align the optical fiber (in Station 10A, about 15 minutes to about 20 minutes) is avoided and/or significantly reduced.

More specifically, referring again to FIGS. 2 and 3A-3C, after the diode laser 320 is attached to the Silicon motherboard 302 the FAC lens 330 and the optical fiber 340 are placed in their respective v-groove positions 315 that are etched into the silicon motherboard 302 (e.g., specifically, the lens v-groove 311, the optical alignment v-groove 312, and optionally the buffer v-groove 313) such that they are passively aligned and attached to the silicon motherboard 302 via their respective v-groove 315 positions.

The v-groove(s) 315 (e.g., the lens v-groove 311 and the optical alignment v-groove 312) should be designed to enable passive alignment of the lens 330 (e.g., the FAC lens) and the optical fiber 340, but at the same time the v-groove(s) 315 should not interfere with the light emission from the p-side (e.g., anode side) mounted laser diode 320. This is facilitated by positioning the laser diode 320 such that the light emission emits into an opening where the passively aligned optics will be placed and attached.

FIG. 4 shows a side view of the optical system including the laser diode 320, the lens 330 (e.g., the FAC lens), and the optical fiber 340 (e.g., the cleaved portion 342 of a MMF fiber) in optical alignment. The output end of the laser diode 320 has an alignment distance (A) from an external surface of the lens 330 that ranges from about 5 microns to about 30 microns, or from about 10 microns to about 20 microns, or from about 15 microns to about 18 microns, or about 17 microns. The lens 330 has an alignment distance (B) from the closest end of the optical fiber 340 that ranges from about 10 microns to about 200 microns, from about 50 microns to about 150 microns, from about 80 microns to about 120 microns, or about 100 microns.

The cleaved portion of the optical fiber lens 330 has an external diameter tolerance on the order of ±1 to 2 microns, for example. The FAC lens 330 has an external diameter (C) and the tolerance of the external diameter (C) is on the order of ±1 to 2 microns, for example. The laser diode 320 has a cathode side 320A and an anode side 320B.

FIG. 5 shows a raytrace that simulates the coupling of light emission from the laser diode through the FAC lens 330 and the optical fiber 340 as depicted from the side of the optical system (e.g., the side of the FAC lens 330 and the side of the optical fiber 340). More specifically, the raytrace shows a simulation of the light emission 321 (e.g., a fast axis emission) from a laser diode chip through a FAC lens 330 and the cleaved portion 342 of the optical fiber 340 that is a MMF fiber, all of which were passively aligned by employing the lens v-groove 311 and the optical alignment v-groove 312 disclosed in association with FIG. 3A, for example. In one embodiment, referring now to FIGS. 4 and 5, the raytrace depicts the light emission 321 from a laser diode 320 that has an alignment distance (A) of about 17 microns from an FAC lens 330. The raytrace also depicts the light emission through the FAC lens 330, which has an alignment distance (B) of about 80 microns from the closest end of an optical fiber 340 (e.g., an end of the cleaved portion 342 of an optical fiber 340). The light emission bends as it exits the FAC lens 330, the bending of the light emission is due to the FAC lens 330. Thereafter the light emission is coupled into the optical fiber 340.

In accordance to the laser emission, the z-axis is defined as the direction of light emission away from the laser diode light emitting facet. Whereas, the corresponding x-axis and y-axis directions are the slow and fast axis directions, respectively. Therefore, the corresponding definitions for the alignment tolerance for the optical layout shown in FIGS. 3A-3C and 4-5 are defined as follows and the alignment tolerances are shown in Table 2:

TABLE 2
Alignment tolerance corresponding to
a 5% and a 10% drop in optical transmission.

| % Drop in Transmission | 5% | 10% |
|---|---|---|
| ΔXlaser diode | ±12 μm | ±16 μm |
| ΔYlaser diode | ±7 μm | ±10 μm |
| ΔA | ±13 μm | ±20 μm |
| ΔB | ±160 μm | ±255 μm |
| ΔYlens | ±5 μm | ±7 μm |
| ΔYcleaved optical fiber | ±10 μm | ±16 μm |

1. ΔXlaser diode is the placement tolerance of the diode laser 320 in the x-direction relative to the optical fiber 340.
2. ΔYlaser diode is the vertical tolerance of the diode laser 320 (this could be impacted e.g., by the quantity of solder placed on the anode side 320A of the laser diode 320).
3. ΔA = the tolerance of the distance between the diode laser 320 and FAC lens 330.
4. ΔB = the tolerance of the distance between the FAC lens 330 and the optical fiber 340.
5. ΔY lens is the vertical tolerance of the lens (e.g., the FAC lens 330).
6. ΔYcleaved optical fiber is the vertical tolerance of the optical fiber 340.

Referring now to FIGS. 2 and 3B, in Station 3B during operation 206 the Silicon motherboard 302 assembly formed in Station 1B during operations 201, 202, 203 and 204 can be placed into and attached to the enclosure 502 and an electrical board 402 can be attached to the enclosure 502.

Referring also to FIGS. 3A and 3B the Silicon motherboard 302 assembly formed in Station 1B features the diode laser 320, the FAC lens 330 and the optical fiber 340 each suitably aligned with one another via the lens v-groove 311 and the optical alignment v-groove 312 that passively align the FAC lens 330 and the optical fiber 340 (specifically, the cleaved portion 342 of the optical fiber). Referring still to FIG. 2, in station 3B the Silicon motherboard 302 formed in Station 1B is solder attached to the enclosure 502 (e.g., the heat sink (HS)) during operation 206. Any of a number of solders may be employed to solder the Silicon motherboard 302 to the enclosure 502 including, for example, 100Sn, SnAg based alloy (e.g., 97Sn3Ag), or any solder having reflow temperature ranges between 100° C. and 400° C.

The electrical board 402 can be made according to a number of methods. For example, the electrical board 402 can be a thick film metalized ceramic having metalized traces 326 for electrical transport of current to and/or from an external power supply to the silicon motherboard 302 via one or more wirebonds 405. The metalized traces 326 can be made from any of a number of conductive materials including, for example, Cu and/or Au. Alternatively, the electrical board 402 can be made according to techniques employed to make standard copper clad PCB boards (printed circuit boards).

The electrical board can have an anode trace 426A and a cathode trace 426B.

The area and thickness of the Copper in the anode conductive trace 426A and the cathode conductive trace 426B is important, because the goal in the electrical board 402 is to transfer as much energy from the anode wire 416A and the cathode wire 416B to and from the silicon motherboard 302 to minimize electrical losses (e.g., series resistance) and thus, minimize additional heat dissipation from the photonics module. In some embodiments, the Anode and Cathode traces 426A, 426B include solder barriers 322 that prevent wicking into certain regions of the Anode and Cathode traces 426A, 426B. The anode wires 416A supply the electricity to the laser diode chip 320. The laser diode 320 is mounted positive-side down (Anode side 320A down) onto a pre-deposited solder 323, which is on top of an anode trace 426A (e.g., an Au anode trace) disposed on the Silicon motherboard 302. The negative side (e.g., the cathode side 320B) of the laser diode 320 is wirebonded 405 (via one or more wirebond 405) to a cathode trace 426B located on the Silicon motherboard 302. An anode trace 426A on the electrical board 402 is connected to the anode trace 426A located on the Silicon motherboard 302 via one or more wirebond 405 and likewise, the cathode trace 426A on the electrical board 402 is connected to a cathode trace 426A located on the Silicon motherboard 302 via one or more wirebond 405. Suitable wirebonding may be accomplished by any of a number of materials including, for example, Au, Al or similar materials.

In some embodiments, the electrical board 402 has one or more wires that go to a thermistor 324. In one embodiment, there are two feedback control wires 410 that go to and from the thermistor 324 via metalized traces 326 that are disposed on the electrical board 402 that connect to the metalized traces 326 on the Silicon motherboard 302 via wirebond 405. The two feedback control wires 410 connect to the environment outside of the photonics module and enable monitoring and control of the temperature of the Silicon motherboard 302 assembly via the thermistor 324, a resistor that is temperature sensitive (e.g., that changes with temperature).

Referring still to FIG. 2, during operation 206 the electrical board 402 is solder attached to the enclosure 502. The electrical board 402 can be, but is not limited to, a thick film, a metalized ceramic, or a PCB board (printed circuit board) with appropriate copper thickness (e.g., from about 0.5 Oz Cu to about 10 Oz Cu). Any of a number of solders may be employed to solder the electrical board 402 to the enclosure 502, such as, for example, SnAg based alloy, or any solder having reflow temperature ranges between 100° C. and 300° C. Other mounting materials may be used alternatively or in addition to Solder, for example, suitable epoxies may be employed including, for example, any silver based thermal epoxy such as, arctic silver epoxy. The takt time for station 3B is about 0.6 minutes.

Referring also to FIGS. 3A and 3B, the enclosure 502 can be, for example, a heat sink (HS). Suitable enclosures 502 are capable of removing heat from one or more of the components to be housed within the enclosure 502. The enclosure 502 may be fabricated from any of a number of materials including, but not limited to, for example, copper, WCu, Aluminum, or any materials having high thermal conductivity.

The enclosure 502 provides mechanical support for the Silicon motherboard 302 assembly, provides thermal properties to facilitate the removal of the heat that is generated by the diode laser chip 320 (e.g., acts as a heat sink), and/or acts as a protective enclosure for the silicon motherboard 302 (including the laser diode 320). Materials suitable for use in the enclosure 502 include metals, examples including but not limited to, Cu, WCu, Al, or combinations thereof. The enclosure 502 may be an injection molded metal, for example, injection molded Copper. Suitable enclosures 502 may be made from metal composites (e.g., a composite of metal and copper). The enclosure 502 could be made from any thermally conductive material including Al. The enclosure 502 may be of unibody construction (e.g., injection molded) or it may be made from two or more parts (e.g., multiple parts) and assembled.

The enclosure can also have a variety of configurations. Referring still to FIG. 3A, in one embodiment, the enclosure 502 has a substantially flat bottom surface 506 and has walls 508 disposed substantially perpendicular to the bottom surface 506. The silicon motherboard 302 and/or the electrical board 402 may be mounted (e.g., permanently or in a removably attachable fashion) to the bottom surface 506 of the enclosure 502 via any suitable means including soldering or adhesive (e.g., epoxy or thermal epoxy), for example.

The enclosure can also include a plurality of spaced-apart positioning elements for engaging the motherboard in a desired position within the enclosure. For example, as shown in FIG. 3A, the enclosure walls 508 may be sized, shaped, and/or positioned on the enclosure 502 to enable proper positioning of the Silicon motherboard 302 and/or the electrical board 402 within the enclosure 502, for example. Suitable walls 508 are sized, shaped and/or positioned to ensure that the Silicon motherboard 302 and/or the electrical board 402 are held in a desired position within the enclosure 502. The walls 508 of the enclosure 502 guide the Silicon motherboard 302 such that, for example, referring to FIGS. 3A and 3B, where the walls 508 of the enclosure 502 are curved at portions G1, G2, G3, G4, G5, and G6 these curved portions act as positioning portions of the walls 508 that aid in proper placement of the Silicon motherboard 302 within the enclosure 502. Suitable walls 508 can be sized, shaped, and/or positioned to similarly position the electrical board 402 to the proper position within the enclosure 502. In this way, portions of the enclosure 502 (e.g., portions of the walls and/or portions of the bottom surface) can aid in positioning the contents that will be held within the enclosure 502 (e.g., the Silicon motherboard assembly) such that proper alignment with other objects can be accomplished. The positioning portions of the enclosure can also provide structural stability that avoids rotation, shifting or other disruptions to the desired alignment of the contents of the enclosure. In this way, the structural stability of the enclosure helps to maintain the optical elements disposed on the silicon motherboard in proper alignment with the laser diode emission. The positioning portions of the enclosure can engage the motherboard in a desired position within the enclosure.

The enclosure can also define a volume sufficient to sequester excess mounting material from the Silicon motherboard. The space between and/or adjacent to the plurality of positioning elements can be configured to receive the mounting material when the motherboard is mounted on the base and can be configured to prevent the mounting material from contacting at least one of a side or a top of the motherboard. Accordingly, the pitch (e.g., the spacing) between adjacent positioning elements or positioning portions and/or the frequency of adjacent positioning elements or positioning portions of the enclosure can be selected to achieve the desired functions of 1) guiding and/or engaging the Silicon motherboard and/or the electrical board within the enclosure 2) providing stability to the contents of the enclosure and 3) providing the desired wicking region adjacent a positioning portion and/or between two positioning portions (e.g., providing a region having a volume sufficient to sequester excess mounting material away from the motherboard). The limit of the pitch is where the positioning portions are so close that they function as a flat wall such that the space adjacent a positioning portion is insufficient to act as a wicking region. The enclosure can remove heat from the contents held therein. In addition, the enclosure, when covered by a lid, can provide the contents held within the enclosure with protection from the external environment.

More specifically, the walls 508 may be sized, shaped, and/or positioned relative to the enclosure 502 such that any wicking (e.g., sequestering) of the mounting material (e.g., the soldering and/or the adhesive) from beneath the surface of the Silicon motherboard 302 avoids contacting the side walls 304 of the Silicon motherboard 302 and/or the top 306 of the Silicon motherboard 302 and/or the side walls and/or the top of the electrical board 402. Likewise any wicking of mounting material from beneath the surface of the electrical board 402 avoids contacting the side walls and/or the top surface of the electrical board 402 and/or the side walls and/or the top of the Silicon motherboard 302. In this way, sizing, shaping and positioning the walls 508 of the enclosure 502 can lessen (e.g., minimize) the risk of shorting the Silicon motherboard 302 and/or the electrical board 402. Referring to FIG. 3B, positioning portions G1, G2, G3, G4, G5 and G6 of the walls 508 of the enclosure 502 guide the placement of the Silicon motherboard 302 assembly within the enclosure 502. Referring to FIG. 3A, between positioning portions G2 and G3 is a region of the enclosure 502 bottom surface 506 labeled “W,” which is outlined by a dotted line. Any excess mounting material (e.g., excess solder and/or glue) can wick (e.g., be sequestered) into the wicking region labeled “W,” where excess mounting material can pool and/or cover at least the footprint of the wicking region W and thereby avoid and/or reduce the risk of shorting the Silicon motherboard 302 due to contacting the side walls 304 and/or the top surface 306 of the Silicon motherboard. FIG. 3A shows that the wicking region W can be formed adjacent the positioning portions G2 and G3, specifically, the wicking region W can be formed between two positioning portions G2 and G3 and/or by the region adjacent to one positioning portion. Specifically, the wicking region W can be formed by a gap between the side wall 304 of the Silicon motherboard 302 and the portions of the enclosure wall 508 (e.g., region Z) that are at a larger distance from the side wall 304 (e.g., the portions of the enclosure wall 508 that do not aid in guiding the Silicon motherboard 302 into position) compared with the positioning portions G2 and G3 of the enclosure wall 508 that guide the Silicon motherboard 302 (and/or the electrical board 402).

The enclosure walls 508 (more specifically, the positioning portions G1, G2, G3, G4, G5 and G6 of the enclosure walls 508) aid in placing the Silicon motherboard 302 assembly and the electrical board 402 in the desired location within the enclosure 502 (e.g., toward the center of the enclosure 502) and the wicking regions “W” formed adjacent positioning portions (e.g., between two positioning portions such as G2 and G3) and the other portions of the enclosure walls 508 that do not aid in positioning the Silicon motherboard 302 and/or the electrical board 402 minimize the possibility of the mounting material (e.g., the solder and/or the adhesive) getting wicked onto the side walls of the Silicon motherboard 304 and/or onto the top 306 of the Silicon motherboard 302 assembly and/or onto the sidewalls or the top of the electrical board 402.

Any of a number of enclosure configurations may be employed to provide the desired functionality described in association with FIGS. 3A and 3B, namely the desired functionality includes the capacity of the enclosure to provide (1) Silicon motherboard assembly (and/or electrical board) positioning within the enclosure, (2) stability that prevents rotation of parts held in the enclosure and aligned by the positioning portions (e.g., prevents rotation of the Silicon motherboard assembly and/or electrical board within the enclosure) and (3) one or more wicking region(s) that minimize and/or eliminate shorting of the Silicon motherboard assembly (and/or electrical board) due to wicking of the mounting material (e.g., the solder or the adhesive).

Suitable enclosures feature two or more positioning elements. More specifically, portions of walls can act as positioning elements within suitable enclosures. Positioning elements can have any of a number of shapes and/or can be columns having any of a number of cross sectional shapes. Exemplary enclosure configurations provide one or more of the features of positioning/mechanical alignment, structural stability and one or more wicking regions; in some embodiments, the enclosure configuration provides all of these features.

Finally, the enclosure can be manufactured such that the bottom surface, walls, wicking region W, and positioning portions G1-G6 are a single piece, e.g., of unibody construction, made, for example, by injection molding.

In some embodiments, the enclosure is manufactured from two or more pieces. For example, the positioning portions are coupled to the bottom surface and/or to the walls. The positioning portions can, for example, be shaped columns having at least one side that fits into a complementary portion of the bottom surface (e.g., a side of a “male” column that fits into a “female” region of the bottom surface and is coupled by, for example, tension fit). The positioning portions can be part of an enclosure wall and the column can be adapted to fit into a complementary portion of the enclosure (e.g., the wall can fit into the bottom surface of the enclosure). Alternatively, the positioning portions can be adapted to couple to the walls of the enclosure.

Referring now to FIG. 3D another embodiment of an enclosure has positioning elements that are columns. Each column H1, H2, H3, H4, H5, and H6 has a substantially circular cross sectional shape. The columns are disposed within the enclosure to provide mechanical alignment capability that aids in aligning the Silicon motherboard and/or the electrical board. The gaps between the columns provide one or more wicking regions (e.g., wicking region WH which is located between columns H2 and H3). Suitable enclosures can include two or more columns, e.g., H1 and H5 or H2 and H5, or H1 and H6. Alternatively, suitable enclosures include three or more columns, for example, H1, H3 and H5 or H1, H2, and H5 or H1, H2 and H6. Alternatively, suitable enclosures include four or more columns, for example, H1, H2, H3 and H4 or H1, H3, H4 and H6. The shaped columns can have at least one side that fits into a complementary portion of the bottom surface (e.g., a side of a “male” column that fits into a “female” region of the bottom surface and is coupled by, for example, tension fit). Thus, in some embodiments, the columns and the bottom surface of the enclosure are not of unibody construction and rather are made from multiple pieces. Suitable enclosures that feature positioning elements (e.g., positioning portions) that are columns can, alternatively, be made of unibody construction.

FIG. 3E shows another embodiment of an enclosure, the enclosure having positioning elements that are columns. Each column I1, I2, I3, I4, I5, and I6 has a polygon cross section. The columns are disposed within the enclosure to provide mechanical alignment capability that aids in aligning the Silicon motherboard and/or the electrical board. The gaps between the columns I1, I2, I3, I4, I5, and/or I6 provide one or more wicking regions (e.g., wicking region WI which is located between columns I2 and I3). Suitable enclosures can include two or more columns, e.g., I1 and I5, or I2 and I5, or I1 and I6. Alternatively, suitable enclosures include three or more columns, for example, I1, I3 and I5 or I1, I2, and I5, or I1, I2 and I6. Alternatively, suitable enclosures include four or more columns, for example, I1, I2, I3 and I4 or I1, I3, I4 and I6. The combination of columns that are employed in the enclosure can have the same cross section or alternatively can have different cross sectional shapes. The position of the polygon cross section can be selected as in columns I2 and I6 such that a pointed tip (e.g., the apex of the triangle in the cross section of a column I2) is the portion of the positioning portion that guides the Silicon motherboard and/or the electrical board into place along a longitudinal axis located substantially in the center of the enclosure. Suitable enclosures can include columns with each column having the same cross sectional shape, with each column having a different cross sectional shape, with two or more columns having the same cross sectional shape, with two or more columns having a different cross sectional shape. Suitable cross sectional shapes include, for example, circle, triangle, quadrilateral (e.g., square, rectangular), pentagon, hexagon, heptagon, octagon or any other suitable polygon that provides the desired characteristics to the enclosure.

The shaped columns can have at least one side that fits into a complementary portion of the bottom surface (e.g., a side of a “male” triangle cross section column I2 that fits into a “female” triangle shaped region of the bottom surface and is coupled by, for example, tension fit). Thus, in some embodiments, the columns and the bottom surface of the enclosure are not of unibody construction and rather are made from multiple pieces. Suitable enclosures that feature positioning elements (e.g., positioning portions) that are columns can, alternatively, be made of unibody construction.

FIG. 3F shows another embodiment of an enclosure, the enclosure walls have two or more portions that are positioning elements (e.g., positioning portions). Specifically, the enclosure walls have four substantially triangular shaped positioning portions labeled J1, J2, J3 and J4. Here, at least a portion of the enclosure walls can be described as having a substantially zigzag or a substantially triangular profile and the wicking region(s) located adjacent a positioning portion (e.g., WJ2 located adjacent positioning portion J2) or between two positioning portions (e.g., wicking region WJ1 between J1 and J2) are substantially polygonal in shape. In some embodiments, the enclosure is made of unibody construction such that the enclosure walls, including the substantially triangular shaped portions and the bottom portion are made from a single piece of material (e.g., injection molded). In other embodiments, the enclosure is made from multiple pieces such that the enclosure walls are permanently or temporally attachable to the enclosure (e.g., attachable to the enclosure bottom). Suitable enclosures can include two or more positioning portions, e.g., J1 and J4, or J1 and J3. Alternatively, suitable enclosures include three or more positioning portions, for example, J1, J2 and J3. Alternatively, suitable enclosures include four or positioning portions for example, J1, J2, J3 and J4. The combination of positioning portions is selected such that the two or more positioning portion(s) guide the Silicon motherboard and/or the electrical board into place and impart stability to the contents held within the enclosure.

FIG. 3G shows another embodiment of an enclosure, the enclosure walls have two or more portions that are positioning portions. Specifically, the enclosure walls have six substantially triangular shaped positioning portions labeled K1, K2, K3, K4, K5 and K6. Here, at least a portion of the walls can be described as having a substantially zigzag or a substantially triangular profile with the wicking region(s) located adjacent a positioning portion (e.g., wicking region WK2 is adjacent positioning portion K3) or between two positioning portions (e.g., wicking region WK1 is between K1 and K2) being substantially polygonal (e.g., substantially triangular) in shape. In one embodiment, the enclosure is made of unibody construction or alternatively it may be made be made from multiple pieces.

Suitable enclosures can include two or more positioning portions, e.g., K1 and K4, or K1 and K5, or K1 and K6. Alternatively, suitable enclosures include three or more positioning portions, for example, K1, K2 and K4, or K1, K3 and K5, or K1, K4 and K3, or K1, K5 and K6. Alternatively, suitable enclosures include four or more positioning portions, for example, K1, K2, K4 and K5. The combination of positioning portions is selected such that the two or more positioning portion(s) guide the Silicon motherboard and/or the electrical board into place within the enclosure. The combination of positioning elements (e.g., positioning portions) may also be selected such that the positioning portions impart stability such that the contents of the enclosure (e.g., the silicon motherboard) remains aligned.

FIG. 3H shows another embodiment of an enclosure, the enclosure walls have two or more portions that are positioning portions, specifically substantially curved positioning portions L1, L2, L3, and L4. The enclosure shown in FIG. 3H is similar to the enclosure described in association with FIGS. 3A and 3B, however, the enclosure shown in FIG. 3H has four positioning portions (whereas the enclosure shown in FIGS. 3A and 3B has six positioning portions).

Specifically, the enclosure walls have four substantially curved positioning portions labeled L1, L2, L3 and L4. Here, at least a portion of the enclosure walls can be described as having a substantially curved profile and the wicking region(s) located adjacent a positioning portion (e.g., wicking region WL2 adjacent L2) or between two positioning portions (e.g., wicking region WL1 between L1 and L2) are substantially curved in shape. In some embodiments, the enclosure is made of unibody construction such that the enclosure walls, including the substantially curved portions and the bottom portion are made from a single piece of material (e.g., injection molded). In other embodiments, the enclosure is made from multiple pieces such that the enclosure walls are permanently or temporally attachable to the enclosure (e.g., to attachable to the enclosure bottom). Suitable enclosures can include two or more positioning portions, e.g., L1 and L4, or L1 and L3. Alternatively, suitable enclosures include three or more positioning portions, for example, L1, L2 and L3. Alternatively, suitable enclosures include four or more columns, for example, L1, L2, L3 and L4. The combination of positioning elements (e.g., positioning portions) is selected such that the two or more positioning portion(s) guide the Silicon motherboard and/or the electrical board into place within the enclosure.

Suitable enclosures can also include both enclosure walls having positioning portions and one or more column that acts as a positioning portion.

In one embodiment, the walls 508 of the enclosure 502 have a size, shape and position that ensure the structural integrity of the enclosure 502 and its contents (e.g., the Silicon motherboard 302 and/or the electrical board 402). In some embodiments, the enclosure 502 provides a thermal mass that accepts the heat generated within the Silicon motherboard 302, thus, in some embodiments, the enclosure 502 provides additional heat capacity for storage of the thermal energy created by the laser diode 320 for some applications. Optionally, the enclosure 502 walls 508 have a size, shape and position that provide a thermal mass to accept the heat generated within the Silicon motherboard.

Referring still to FIG. 2, in another implementation of operation 206 the electrical board 402 is attached to the enclosure 502 separately from the attachment of the Silicon motherboard 302 to the enclosure 502 and such a change increases the number of assembly steps required to make the improved photonics module by one additional assembly step. By separating the steps of electrical board 402 attachment and Silicon motherboard 302 assembly attachment, the takt time would increase by about the time it takes to solder attach the electrical board 402 to the enclosure 502, which takes from about 0.3 minutes to about 0.6 minutes.

Referring now to FIGS. 2, 3A and 3B, in station 4B the Silicon motherboard 302 and the electrical board 402 attached in the enclosure 502 are wirebound 405 during operation 207. The enclosure 502 is wirebond 405 with a suitable wirebond material, for example an Au wire, Al wire or other suitable material.

In the wirebond module of operation 207 wirebonds 405 are made to connect the electrical board 402 metalized traces 326 to the metalized traces 326 on the silicon motherboard 302 assembly. The wirebonds 405 enable electrical transport of current to and/or from an external power supply through the electrical board 402 to the Silicon motherboard 302 assembly. The electrical board can have an anode trace 426A and a cathode trace 426B. The laser diode 320 is mounted positive-side down (Anode side 320A down) onto a pre-deposited solder 323, which is on top of an anode trace 426A disposed on the Silicon motherboard 302 assembly. The negative side (e.g., the cathode side 320B) of the laser diode 320 is wirebonded 405 (via one or more wirebond 405) to a cathode trace 426B located on the Silicon motherboard 302 assembly. An anode trace 426A on the electrical board 402 is connected to the anode trace 426A located on the Silicon motherboard 302 via one or more wirebond 405 and likewise, the cathode trace 426A on the electrical board 402 is connected to a cathode trace 426A located on the Silicon motherboard 302 via one or more wirebond 405.

The size of the wirebond wire chosen should be suitable for the current handling capability. Suitable wires have a diameter that ranges from about 0.5 mil to about 5 mil, or from about 1 mil to about 1.3 mil, for example. In one embodiment, a 1.3 mil diameter Au wire was used. The wire can be bonded with ball or wedge bonds, for example. In order to achieve a high throughput through this operation (e.g., a lower takt time) gold ball bonds should be used. The takt time for station 4B is about 0.3 minutes.

Referring to FIGS. 2, 3A, 3B, 6A and 6B in the process diagram of FIG. 2 in station 5B the lid 600 is attached to the enclosure 502 and is sealed during operation 208 in which the Lid Attach & Sealing takes place. The lid 600 can be made from any of a number of materials including metal or plastic. In one embodiment, plastic is employed for cost control reasons. The lid bottom 604 can have features 608 that align with the complimentary walls 508 of the enclosure 502. The lid bottom 604 has a tunnel 610 that when assembled with the enclosure 502 allows the optical fiber to exit the lidded enclosure without disturbing the optical fiber position and/or function. In FIG. 2 in station 5B the lid 600 is attached to the top of the enclosure 502. The lid 600 is sealed with any suitable material, for example, with an appropriate epoxy/glue. In one embodiment, the lid 600 is a protective lid 600 that protects the laser diode 320 and/or the entire Silicon motherboard 302 assembly and/or the electrical board 402 from the external environment. The lid 600 could be placed on top of the enclosure 502 to cover the Silicon motherboard 302 assembly and the electrical board 402 that are housed within the enclosure 502 and to protect these components from the external environment. The lid 600 can protect the laser diode 320 and other components housed inside of the enclosure 502 from, for example, possible environmental damage or contamination. Any of a number of lid configurations may be employed so long as the lid complements the enclosure such that the contents of the enclosure are protected from the external environment and/or the optical fiber is allowed to exit the enclosure without disruption. More specifically, the lid may be selected to complements the walls, the wicking region, and the optical fiber exit route(s) of the given enclosure (e.g., the lid features and the tunnel(s) will be positioned to complement the selected enclosure). The takt time for station 5B is about 1 minute.

In station 6B the Final Test (LIV, WL) occurs during operation 209. In this test the final electro-optic characteristics are measured. In particular the operating voltage, optical power and wavelength are measured according to means and methods known to individuals who are skilled in the field of photonics. The takt time for station 6B is about 1 minute.

The exemplary improved process flow disclosed in accordance with FIG. 2 requires 9 operations, 6 stations, 1 wirebond operation, no active alignment steps, and 1 test operation. The total sequential takt time for the process disclosed in association with FIG. 2 is 6.9 minutes. The total sequential takt time for the process disclosed in association with FIG. 2 is several orders of magnitude shorter than the 43 minutes of total sequential takt time required to complete the prior art process disclosed in association with FIG. 1.

While only certain embodiments have been described, it will be understood by those skilled in the art that various changes in form and details may be made therein without departing from the spirit and scope as defined by the appended claims. Those skilled in the art will recognize, or be able to ascertain using no more than routine experimentation, many equivalents to the specific embodiments described specifically herein. Such equivalents are intended to be encompassed in the scope of the appended claims.

The patent, scientific and medical publications referred to herein establish knowledge that was available to those of ordinary skill in the art. The entire disclosures of the issued U.S. patents, published and pending patent applications, and other references cited herein are hereby incorporated by reference.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent or later-developed techniques which would be apparent to one of skill in the art. In addition, in order to more clearly and concisely describe the claimed subject matter, the following definitions are provided for certain terms which are used in the specification and appended claims.

As used herein, the recitation of a numerical range for a variable is intended to convey that the embodiments may be practiced using any of the values within that range, including the bounds of the range. Thus, for a variable which is inherently discrete, the variable can be equal to any integer value within the numerical range, including the end-points of the range. Similarly, for a variable which is inherently continuous, the variable can be equal to any real value within the numerical range, including the end-points of the range. As an example, and without limitation, a variable which is described as having values between 0 and 2 can take the values 0, 1 or 2 if the variable is inherently discrete, and can take the values 0.0, 0.1, 0.01, 0.001, or any other real values≧0 and ≦2 if the variable is inherently continuous. Finally, the variable can take multiple values in the range, including any sub-range of values within the cited range.

As used herein, unless specifically indicated otherwise, the word “or” is used in the inclusive sense of “and/or” and not the exclusive sense of “either/or.”

What is claimed is:

1. A photonics module, comprising:
a motherboard having a laser diode disposed thereon and further comprising a channel configured to receive an optical fiber and align it with the diode; and
an enclosure comprising a base onto which the motherboard is mounted and a plurality of spaced-apart positioning elements for engaging the motherboard in a desired position within the enclosure, wherein the enclosure further defines a volume sufficient to sequester excess mounting material from the motherboard.

2. The photonic module of claim 1, wherein the plurality of spaced-apart positioning elements extend from the base.

3. The photonic module of claim 1, wherein the motherboard is disposed within a cavity, the cavity defined by the base and sidewalls extending from the base, wherein the plurality of spaced-apart positioning elements extend from the sidewalls.

4. The photonics module of claim 1, wherein the mounting material couples the motherboard to the base.

5. The photonics module of claim 4, wherein a space between the plurality of positioning elements is configured to receive the mounting material when the motherboard is mounted on the base.

6. The photonics module of claim 1, wherein a space between the plurality of positioning elements is configured to prevent the mounting material from contacting at least one of a side or a top of the motherboard.

7. The photonics module of claim 1, wherein at least one positioning element is a portion of an enclosure wall.

8. The photonics module of claim 1, wherein at least one positioning element is a column.

9. The photonics module of claim 8, wherein the column extends from the base.

10. The photonics module of claim 1, wherein the channel comprises a v-groove disposed along a major dimension of the motherboard.

11. The photonics module of claim 1, further comprising a second channel configured to receive and align a lens such that the lens is disposed between the diode and the optical fiber.

12. The photonics module of claim 11, further comprising a lens disposed in the second channel such that the lens transmits emission of the diode into the optical fiber.

13. The photonics module of claim 11, wherein the second channel extends along a minor dimension of the motherboard.

14. The photonics module of claim 12, wherein each of the lens and the optical fiber are coupled within their respective channel by one or more of an epoxy, a solder, or combination thereof.

15. The photonics module of claim 1, further comprising a lid that covers a surface of the enclosure to protect contents disposed within the enclosure.

16. The photonics module of claim 1, wherein the base is substantially flat.

17. The photonics module of claim 1, wherein a space adjacent the plurality of positioning elements is configured to receive the mounting material when the motherboard is mounted on the base.

18. The photonics module of claim 1, wherein the enclosure is a heat sink.

19. A photonics module, comprising:
a laser diode disposed on a top surface of a Silicon motherboard, the Silicon motherboard comprising a plurality of v-grooves;
a lens for collimating a laser diode emission;
an optical fiber, wherein the Silicon motherboard comprises one v-groove sized to hold the lens and another v-groove sized to hold the optical fiber, wherein the lens and the optical fiber optically align with the laser diode emission when held by their respective v-groove; and
an enclosure comprising two or more positioning portions that locate the Silicon motherboard in a desired position within the enclosure, wherein the enclosure has a base portion and the two or more positioning portions are spaced from one another such that mounting material disposed between the enclosure base portion and the bottom of the Silicon motherboard wicks into a space adjacent a positioning portion.

20. The photonics module of claim 19, wherein the mounting material wicks into a space between the two or more positioning portions.

21. The photonics module of claim 20, wherein the space between two or more positioning portions enables the mounting material to avoid contacting at least one of the sides of the Silicon motherboard and the top of the Silicon motherboard.

22. The photonics module of claim 19, wherein at least one positioning portion is a portion of an enclosure wall.

23. The photonics module of claim 19, wherein at least one positioning portion is a column.

24. The photonics module of claim 19, wherein one v-groove is disposed along the major flats of the Silicon motherboard and another v-groove is disposed along the minor flats of the Silicon motherboard.

25. The photonics module of claim 19, wherein each of the lens and the optical fiber are attached within their respective v-groove by one or more of an epoxy, a solder, or combination thereof.

26. The photonics module of claim 19, further comprising a lid that covers a surface of the enclosure to protect contents disposed within the enclosure.

27. The photonics module of claim 19, wherein the enclosure has a substantially flat base portion.

28. A method of making a photonics module, the method comprising:
providing a Silicon motherboard comprising a plurality of v-grooves;
disposing a laser diode on a top surface of the Silicon motherboard;
placing a lens in a lens v-groove disposed along the minor flats and sized to hold the exterior dimensions of the lens;
placing an optical fiber in an optical fiber v-groove disposed along the major flats and sized to hold the exterior dimensions of the optical fiber, wherein the lens and the optical fiber optically align with the a laser diode emission emitted from the laser diode when held by their respective v-grooves; and
disposing the Silicon motherboard in an enclosure comprising two or more positioning portions that locate the Silicon motherboard in a desired position within the enclosure.

29. The method of claim 28, further comprising:
cleaving the optical fiber from a bare fiber prior to placing the optical fiber in the optical fiber v-groove.

30. The method of claim 28, further comprising:
disposing an electrical board in the enclosure.

31. The method of claim 30, wherein the Silicon motherboard and the electrical board are disposed in the enclosure substantially simultaneously.

32. The method of claim 28, wherein the laser diode is disposed on the top surface of the Silicon motherboard prior to providing the Silicon motherboard.

33. A photonics module, comprising:
a motherboard comprising a channel configured to receive an optical fiber and to align the optical fiber with a laser diode emission; and
an enclosure having a base portion and two or more positioning elements that locate the motherboard in a desired position within the enclosure, wherein the two or more positioning elements are spaced from one another such that mounting material disposed between the base portion and the bottom of the motherboard wicks into a space adjacent a positioning element.

34. The photonics module of claim 33, wherein the enclosure is a heat sink.

35. The photonics module of claim 33, wherein the two or more positioning elements maintain the motherboard in substantially the desired position within the enclosure.

36. The photonics module of claim 33, further comprising a lid that covers a surface of the enclosure to protect contents disposed within the enclosure.

37. The photonics module of claim 33, wherein the enclosure has a substantially flat base portion.

38. The photonics module of claim 33, wherein the motherboard further comprises another channel configured to hold a lens, wherein the lens and the optical fiber optically align with the laser diode emission when held by their respective channel.

39. The photonics module of claim 33, wherein the channel comprises a v-groove.

40. The photonics module of claim 39, wherein the motherboard further comprises another v-groove sized configured to hold a lens, wherein the lens and the optical fiber optically align with the laser diode emission when held by their respective v-groove.

41. The photonics module of claim 33, wherein the optical fiber further comprises a lens.

42. The photonics module of claim 33, wherein a laser diode is disposed on a top surface of the motherboard.

43. The photonics module of claim 42, wherein the laser diode comprises a lens.
